(19) United States
(12) Patent Application Publication
(10) Pub. No.: US 2026/0212540 A1
(43) Pub. Date: Jul. 23, 2026

(54) LONG VIDEO UNDERSTANDING FOR VIDEO-BASED VISUAL LANGUAGE MODELS

(71) Applicant: NVIDIA Corp., Santa Clara, CA (US)

(72) Inventors: Jindong Jiang, Highland Park, NJ (US); Wonmin Byeon, Santa Cruz, CA (US); Xiuyu Li, Emeryville, CA (US); Yao Lu, Palo Alto, CA (US)

(73) Assignee: NVIDIA Corp., Santa Clara, CA (US)

(21) Appl. No.: 19/453,348

(22) Filed: Jan. 20, 2026

Related U.S. Application Data
(60) Provisional application No. 63/747,293, filed on Jan. 20, 2025.

(51) Int. Cl. G06T 9/00; G06N 3/048; G06T 3/4046

(52) U.S. Cl. CPC G06T 9/002; G06N 3/048; G06T 3/4046

(57) ABSTRACT

Video-based multimodal large language models that include an image encoder configured to transform frames from a video into visual tokens, a multimodal large language model configured to receive the visual tokens, and a temporal module interposed between the image encoder and the multimodal large language model.

### CROSS-REFERENCE TO RELATED APPLICATIONS

This application claims priority and benefit under 35 U.S.C. 119(e) to U.S. Application No. 63/747,293, “Long Video Understanding for Video-Based Visual Language Models”, filed on Jan. 20, 2025, the contents of which are incorporated herein by reference in their entirety.

### BACKGROUND

Recent advancements in video-based multimodal large language models (VLLMs) demonstrate improved video interpretation by processing videos as sequences of image frames.

However, conventional approaches often utilize frame-level representations without explicit temporal encoding, leading to inefficiencies in handling long video sequences and limitations in interpreting temporal dynamics.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1A depicts a conventional multimodal pipeline.

FIG. 1B depicts an embodiment of a multimodal pipeline with temporal enhancement.

FIG. 1C depicts an embodiment of a multimodal pipeline with temporal enhancement and temporal token compression.

FIG. 1D depicts an embodiment of a multimodal pipeline with temporal enhancement and both of temporal and spatial token compression.

FIG. 2A depicts a video-based multimodal large language model in accordance with one embodiment.

FIG. 2B depicts examples of temporal and spatial pooling.

FIG. 3A-FIG. 3N depict exemplary video clips, queries, and responses.

### DETAILED DESCRIPTION

Disclosed herein are mechanisms integrating a temporal encoder between an image encoder and a large language model, enhancing temporal reasoning and computational efficiency. The disclosed mechanisms may utilize a particular state space model that processes videos by encoding spatiotemporal features into visual tokens.

The disclosed mechanisms compress redundant frame information into state representations thereby reducing token count while retaining the representation of essential temporal dynamics. Further disclosed herein are training-based compression techniques, including temporal and spatial token pooling, that optimize information preservation and minimize redundancy.

The disclosed mechanisms may reduce computational demands on large language models while improving output quality. The disclosed mechanisms may enable efficient and robust video understanding over extended temporal contexts.

A temporal encoder disposed between an image encoder and a large language model may be utilized to bridge the gap between visual representations in a video and corresponding language representations. The disclosed mechanisms integrate temporal dynamics earlier in the transformation pipeline than do conventional mechanisms, thereby enhancing both the temporal reasoning capabilities of video large language models and also their computational efficiency.

The disclosed mechanisms inject temporal information directly into visual tokens which reduces the temporal reasoning burden on the large language model. This enables the large language model to focus processing on higher-level language tasks.

A particular state space model, e.g., the Mamba State Space Model, may be utilized as the core of a temporal layer. Deploying the Mamba State Space Model in this manner enables efficient processing of long videos while enhancing generalization to extended temporal contexts. The temporal layer processes image and video inputs differently. For images, the temporal layer functions as a spatial scanner that enhances tokens by incorporating global spatial context. For videos, the temporal layer performs simultaneous spatial and temporal scanning that captures comprehensive spatiotemporal features.

The temporal layer compress time-series information in the video into state representations. Consecutive frames in the video input often contain redundant information.

The temporal encoder efficiently processes and propagates temporal information across the entire video sequence. The resulting visual tokens inherently encapsulate temporal history, effectively summarizing temporal dynamics of the video. This characteristic enables the extraction of fewer visual tokens for large language model processing while preserving key information.

The disclosed mechanisms may implement token reduction to reduce computational costs and also enhance performance across various scenarios. The training-based compression mechanisms utilized may also include temporal and spatial token compression. Temporal pooling reduces the number of tokens along the temporal dimension, while spatial average pooling decreases tokens per frame. These compression mechanisms may be optimized during training to preserve essential spatiotemporal features while minimizing redundancy.

Unlike conventional mechanisms that directly sub-sample raw video frames, leading to a loss of critical information, the disclosed mechanisms may preserve essential temporal information in a compressed format. The disclosed mechanisms may not only reduce the computational load on the large language model but may also improve model performance through more comprehensive video representation in a compact token space.

A State Space Model (SSM) establishes a linear transformation between an input sequence x_{1:T} ∈ [symbol] and an output sequence y_{1:T}∈ [symbol] through a recurrent process: hₜ=A̅ₜ̅hₜ₋₁+B̅ₜ̅xₜ, yₜ=Cₜhₜ. (1)
where T is the sequence length; xₜ, yₜ∈ [symbol] are input and output vectors at time t, and hₜ∈ [symbol] is the hidden state summarizing the history x≤t. The matrices A̅ₜ̅ ∈ [symbol] , B̅ₜ̅∈ [symbol] and Cₜ∈ [symbol] are parameterized with learnable weights designed to facilitate the modeling of long-term dependencies. When A̅ₜ̅, B̅ₜ̅, C, are time-invariant (constant over t), the computation of y_{1:T} may be parallelized, enabling efficient training and inference.

A Mamba-based SSM conditions these matrices on the input xₜ to enhance the sequence modeling capabilities. Mamba employs learnable functions Ā: [symbol] → [symbol] :B̅: [symbol] → [symbol] , and C: [symbol] → [symbol]
to generate input-dependent matrices:

$${\overline{A}}_{t} = \overline{A} ( {x}_{t} ) , {\overline{B}}_{t} = \overline{B} ( {x}_{t} ) , {C}_{t} = C ( {x}_{t} ) \qquad ( 2 )$$

enabling the model to dynamically emphasize or suppress information based on the current input, thereby enabling more flexible and adaptive sequence modeling. Mamba may implement a hardware-aware parallel algorithm to help ensure that the input-dependent matrices do not hinder the training and inference efficiency inherent to SSMs.

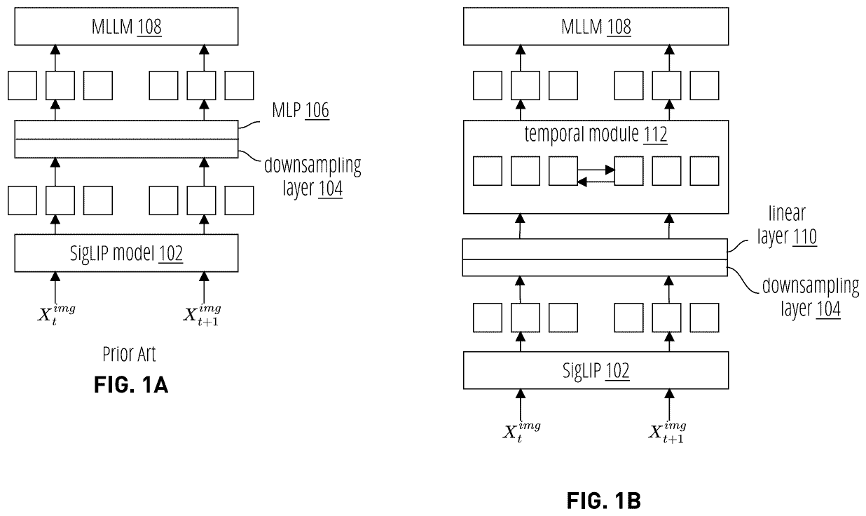

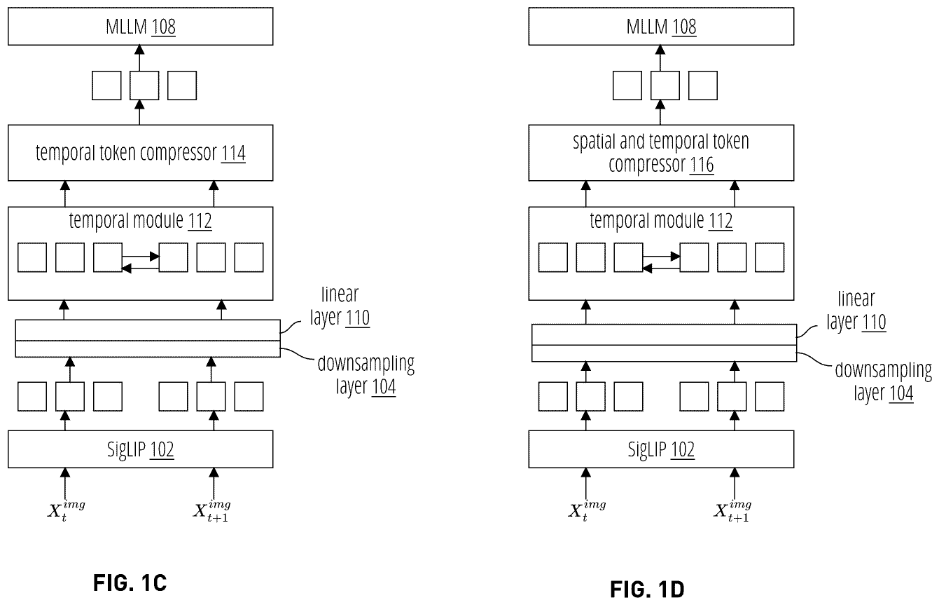

FIG. 1A depicts a conventional multimodal pipeline comprising a SigLIP model 102, a pixel-shuffle downsampling layer 104 a multilayer perceptron 106 projector, and a multimodal large language model 108.

SigLIP (short for Sigmoid Loss for Language-Image Pre-training) is a multimodal vision-language AI model trained to jointly understand images and text by embedding them into the same vector space. similar in structure to CLIP (Contrastive Language-Image Pre-training), with separate encoders for images and text. Both modalities are mapped into a shared embedding space where similarity can be directly measured.

Traditional CLIP applies a softmax-based contrastive loss over an entire batch of image-text pairs, which requires normalization across all pairwise similarities within the batch.

SigLIP replaces this with a pairwise sigmoid loss. This loss operates independently on each image-text pair without global softmax normalization.

When trained on large image-text pair datasets, SigLIP may be utilized for tasks such as zero-shot image classification (classify images without fine-tuning on labeled data), image-text similarity scoring, and image retrieval based on textual queries.

FIG. 1B depicts an embodiment of a multimodal pipeline with temporal enhancement.

In The multilayer perceptron 106 is replaced with a linear layer 110 and a Mamba-based temporal module 112 is interposed between the linear layer 110 and the multimodal large language model 108.

Mamba refers to a new family of sequence models that replace or augment Transformers. Mamba networks utilize a selective state-space model architecture that can process long sequences linearly in time and memory, unlike Transformers which scale quadratically with sequence length. Mamba models comprise is a deep neural network architecture for sequence modeling (like language modeling, speech, DNA sequences, time-series), built on a particular type of state-space model. Whereas traditional SSMs are linear dynamical systems, Mamba comprises a selective mechanism that makes them behave more like the Transformers they replace. This enables Transformer-level performance with efficiency similar to recurrent neural network architectures.

The Mamba-based temporal module 112 propagates spatiotemporal information in each visual token output to the multimodal large language model 108.

FIG. 1C depicts an embodiment of a multimodal pipeline with temporal enhancement 112 and temporal token compression 114, and FIG. 1D depicts an embodiment of a multimodal pipeline with temporal enhancement 112 and both of temporal and spatial token compression 116. The temporal and spatial token compression 116 enables the multimodal large language model 108 to process longer video sequences more efficiently than conventional mechanisms.

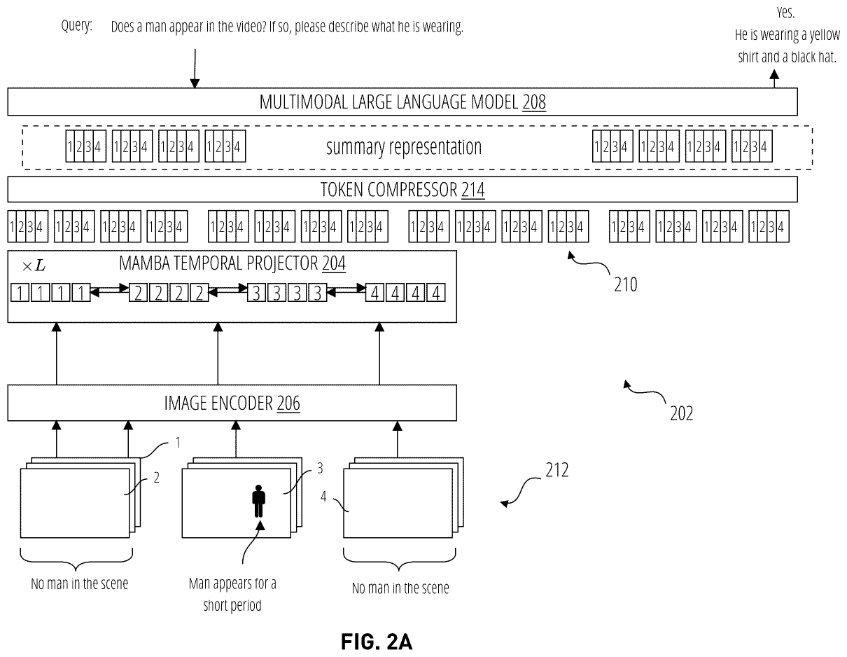

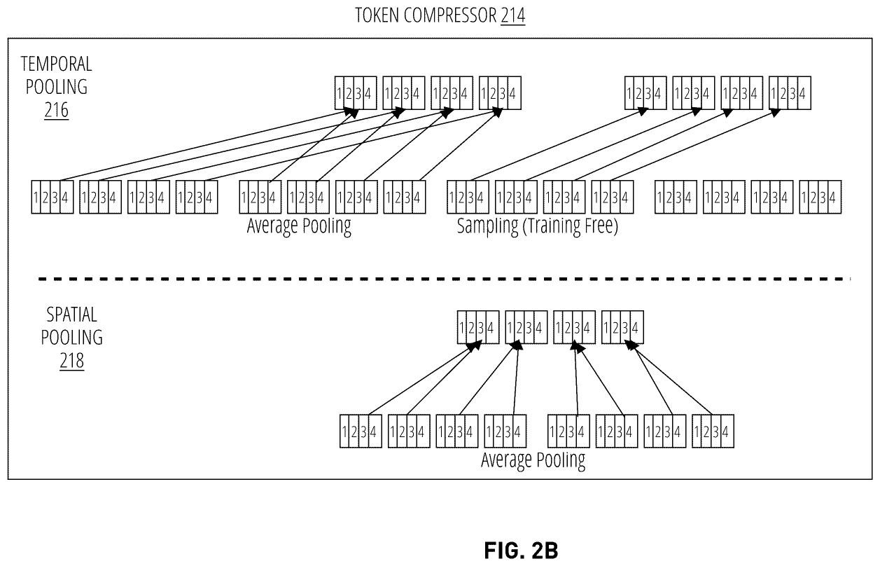

FIG. 2A depicts a video-based multimodal large language model 202 in accordance with one embodiment. A Mamba-based temporal projector 204 is interposed between an image encoder 206 and a multimodal large language model 208. The Mamba temporal projector 204 merges visual and language feature representations while injecting temporal information into the tokens 210 provided to the multimodal large language model 208. The processed tokens naturally capture temporal history, effectively summarizing the temporal dynamics of the input video 212. This configuration enables reduction by the token compressor 214 of the number of for multimodal large language model 208 processing without sacrificing performance.

The Mamba temporal projector 204 efficiently integrates temporal information across video frames while enabling effective temporal token compression. Let Xₜ∈ [symbol] denote the image tokens for frame t by a Vision Transformer (ViT) encoder, where \hat{N} is the number of tokens per frame and D is the token dimension.

The linear layer 110 downsamples the tokens of each frame to

$$\frac{\hat{N}}{r}$$

tokens: \tilde{X}ₜ=Linear (Xₜ), for t=1, . . . , T (3)
where r is the downsample ratio. For simplicity, define

$$N = \frac{\hat{N}}{r} .$$

The downsampled tokens from all frames are stacked to form the input tensor for the temporal module:

$$\tilde{X} = [ {\tilde{X}}_{1} ; {\tilde{X}}_{2} ; … ; {\tilde{X}}_{T} ] ∈ \text{?} \qquad ( 4 )$$

The Mamba temporal projector 204 comprises a number L of Mamba layers that iteratively integrate temporal dynamics into the tokens. In each layer l=1, . . . , L, temporal information is fused into the visual tokens generated by the image encoder 206 by:

$${X}^{( l )} = {X}^{( l - 1 )} + MambaMixer ( Norm ( {X}^{( l - 1 )} ) ) \qquad ( 5 )$$

where X⁽⁰⁾=\tilde{X}, and Norm(⋅) denotes layer normalization. Each MambaMixer comprises a bidirectional scanning module that encodes dependencies in both spatial and temporal dimensions. A sweeping scan order may be applied within each frame and across frames, i.e., left-to-right, top-to-bottom, and frame-to-frame. After L layers, the resulting tokens are enriched with temporal information, denoted as X^{(L)}∈ [symbol] .

One method for training the video-based multimodal large language model 202 comprises two stages. In the first stage (Alignment Stage), parameters of both of the image encoder 206 and the multimodal large language model 208 are frozen, and training is applied only to the Mamba temporal projector 204 using a small image-text dataset. The Mamba layers of the Mamba temporal projector 204 perform temporal and spatial scans within images, so that video inputs are not strictly required to train the Mamba temporal projector 204.

In the second stage (supervised fine-tuning stage—SFT), all three of the image encoder 206, Mamba temporal projector 204, and multimodal large language model 208 are trained using a large and diverse dataset that includes text-only, image-text, and video-text data

Another method for training the video-based multimodal large language model 202 comprises three stages. Building upon the two-stage method, the three-stage method improves training efficiency by splitting the SFT stage into a fast SFT stage and a long-video fine-tuning stage. Stage 1 remains the same as in the first training method. In Stage 2, supervised fine-tuning is performed with shorter videos. For example, training may be applied using video-text data using 8-frame inputs without applying spatial or temporal compression, thereby improving training efficiency. Stage 3 involves a brief fine-tuning phase using, for example, 32-frame video inputs and applying the corresponding compression mechanisms for some percentage (e.g., 20%) of the total training steps (i.e., 0.2 epochs). This final stage allows the model to adapt to longer video sequences and the compression process with reduced additional training cost.

FIG. 2B depicts an example of temporal pooling 216 and spatial pooling 218 by the token compressor 214. The temporal pooling 216 may be implemented as average pooling to compress visual information carried in the visual tokens. Features from consecutive frames are combined by averaging their enriched visual tokens. For tokens X^{(L)}∈ [symbol] generated by the Mamba temporal projector 204, average every k consecutive frames:

[symbol]

$${X}_{time - avg} = \frac{1}{k} {\sum }_{i = 0}^{k - 1} {x}_{t + i}^{( L )} , \qquad ( 6 )$$

$$for t = 0 , k , 2 k , … , T - k$$

resulting in compressed tokens:

$${X}_{time - avg} ∈ \text{?} , \qquad ( 7 )$$

Temporal averaging effectively decreases the number of tokens the multimodal large language model 208 processes, with minimal loss of critical information.

The spatial pooling 218 may also be implemented as average pooling in the spatial domain. Given the input X^{(L)}∈ [symbol] from the visual image encoder 206 and a spatial compression ratio p, apply average pooling with a kernel size and stride of p on each frame, resulting in

$${X}_{space - avg} ∈ \text{?} .$$

After processing through the Mamba temporal projector 204, each visual token is enriched with spatiotemporal information, capturing features not only from its corresponding frame but also from other frames across the entire video. This encoding of global information enables the subsampling of the visual tokens along the temporal dimension, reducing the number of tokens fed into the multimodal large language model 208 without significant loss of information or performance.

Let X′∈ [symbol] denote the tokens provided for subsampling. These may be tokens from visual encoder X^{(L)}, or tokens output from compression modules X_{time-avg} or X_{space-avg}. Here, T′ and N′ are the temporal and spatial dimensions after any temporal or spatial pooling. Uniform subsampling may be applied at rate s along the temporal dimension:

$${X}_{time - skip} = \{ {X}_{t}^{′} \vert t = 0 , k , 2 k , … , T - 1 \} ∈ \text{?} , \qquad ( 8 )$$

This subsampling algorithm may maintain performance on various video understanding benchmarks and may actually improve understanding by reducing noise from redundant frames.

The disclosed mechanisms may be applied to process free-form queries about complex long video scenes. The Mamba-based temporal encoder module 112 determines essential spatiotemporal cues while compressing redundant frame information, enabling efficient, accurate long-video understanding that may outperform conventional mechanisms on a wide range of video understanding tasks.

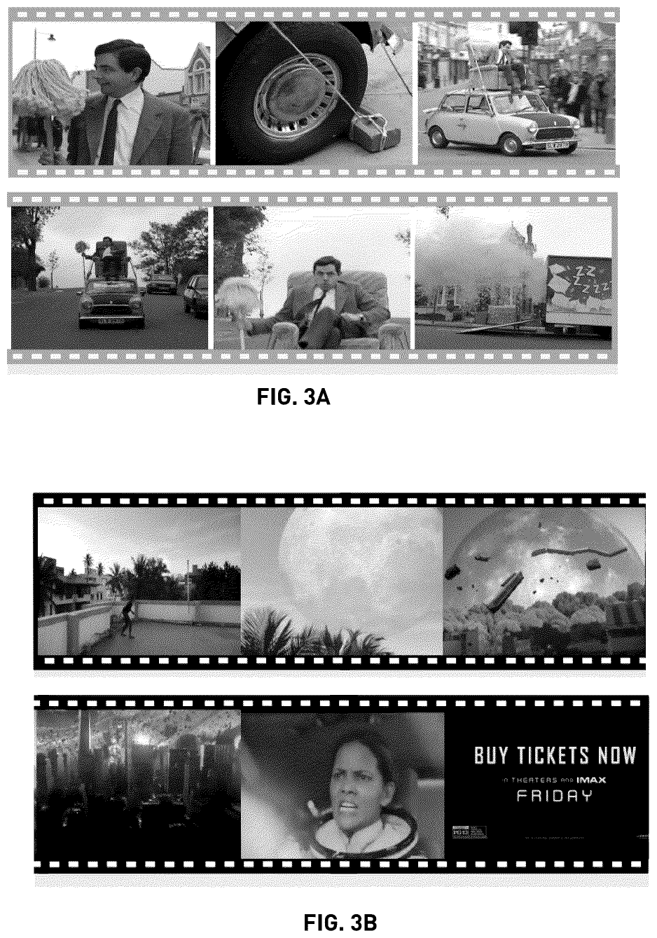

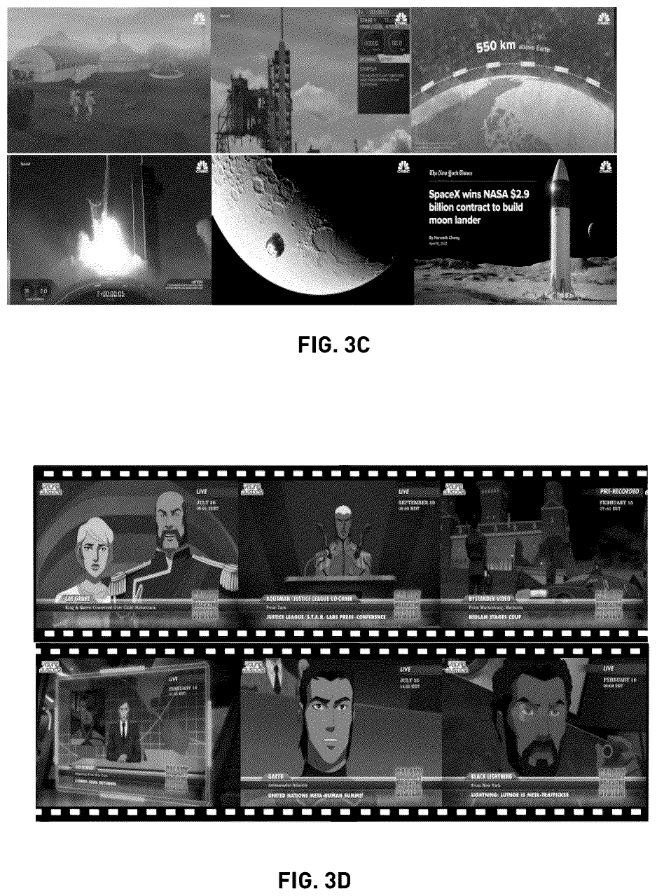

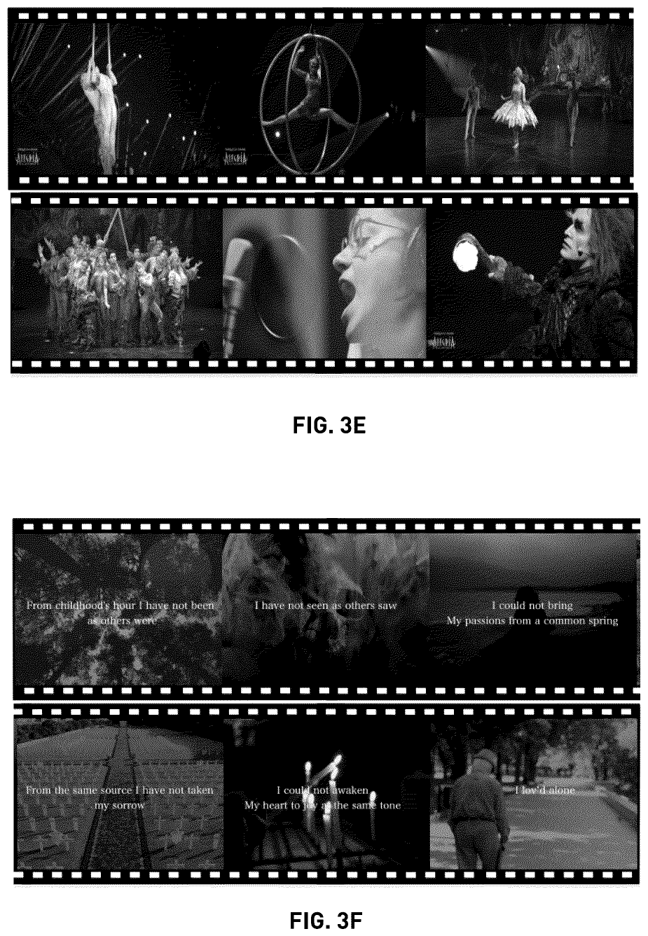

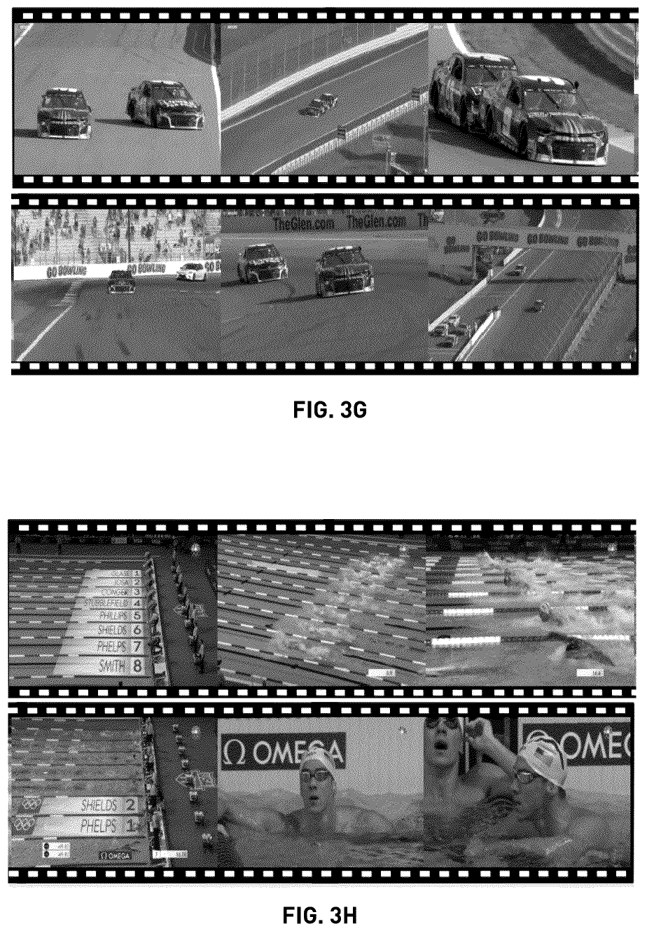

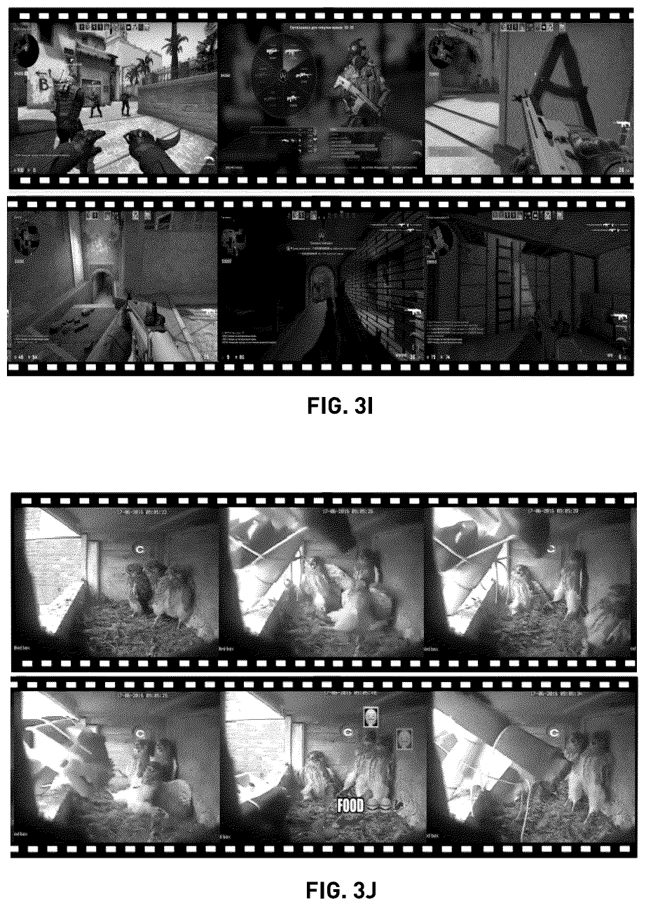

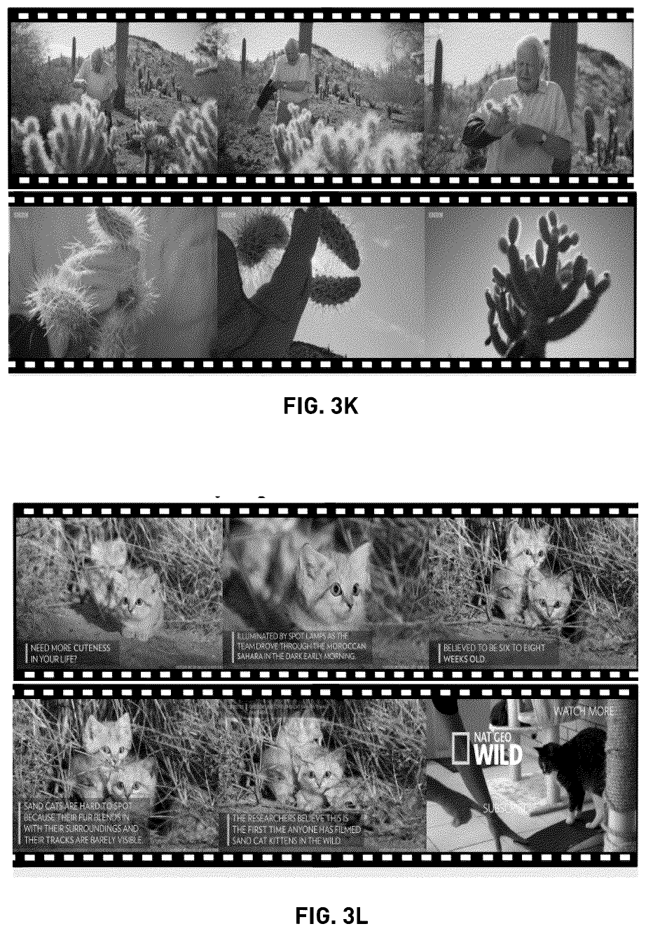

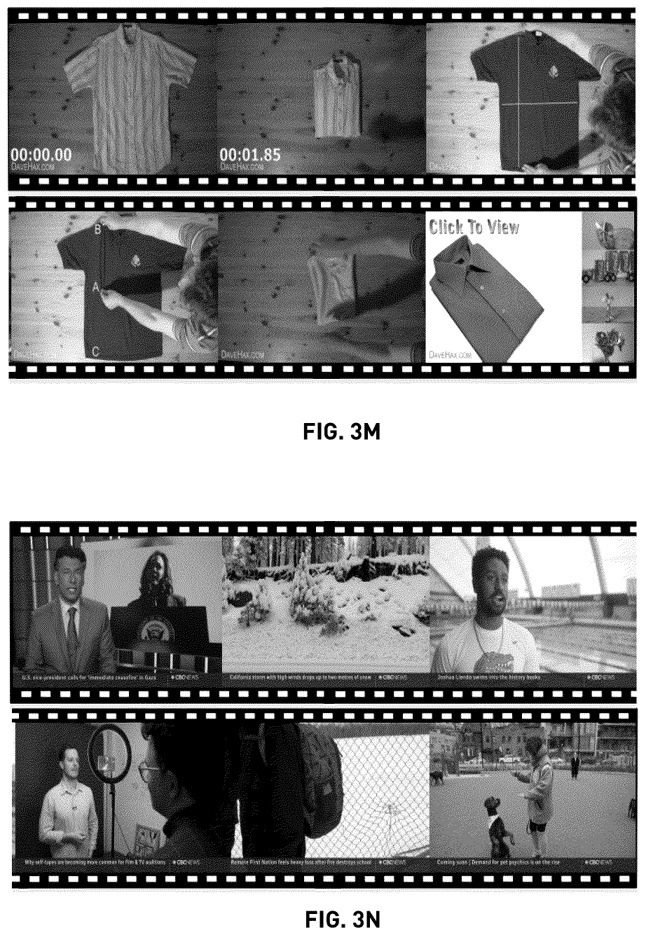

For example, referring to FIG. 3A, the disclosed mechanisms may respond to a query such as “What is funny about the video?” with “The video is funny because it shows a man driving a car with a chair on top of it, which is an unusual and unexpected sight. The man also appears to be enjoying himself, which adds to the humor of the situation.”

Referring to FIG. 3B, the disclosed mechanisms may respond to a query such as “Please provide a description of the narrative of the video” with “The video begins with a person playing with a ball on a rooftop, which is disrupted by a large, glowing moon-like object in the sky. The person looks up in awe as the moon-like object grows larger and more detailed. The scene transitions to a close-up of the moon-like object, which then explodes, causing chaos on the rooftop. The person and a child run away from the explosion, and the scene shifts to a view of the moon-like object in space, surrounded by debris. The person and the child watch the moon-like object on a television, which then explodes, causing a massive fireball. The video then shows a cityscape with buildings exploding and debris flying everywhere, followed by a view of a city under attack with spaceships and debris in the sky. The scene transitions to a chaotic cityscape with buildings collapsing and debris flying everywhere. A person in a red shirt is seen running through the debris, followed by a view of a city under attack with spaceships and debris in the sky. The scene shifts to a close-up of a person in a spacesuit inside a spacecraft, looking out at the chaotic scene outside. The video concludes with a black screen displaying the text ‘BUY TICKETS NOW IN THEATERS AND IMAX FRIDAY’ along with a rating of ‘PG-13’ and the logo of the production company, Lionsgate.”

Referring to FIG. 3C, the disclosed mechanisms may respond to a query such as “What does this video tell? The best answer is A. The process of building a starship. B. Why Starship is the holy grail for SpaceX. C. Why Starlink is crucial to SpaceX's success. D. How SpaceX could Win The Space Race” with “D.”

Referring to FIG. 3D, the disclosed mechanisms may respond to a query such as “How many times do news segments appear in this video? The best answer is: A. 2. B. 4. C. 6. D. 8.” with “C.”

Referring to FIG. 3E, the disclosed mechanisms may respond to a query such as “What is unique about the last performance? The best answer is: A. The last performance features background dancers, distinguishing it from the others. B. The stage lighting is noticeably dimmer in the last performance compared to the others. C. Musical instruments are incorporated into the last performance, unlike the others. D. The last performance showcases a collective group of performers, while the others consist of individual acts” with “C.”

Referring to FIG. 3F, the disclosed mechanisms may respond to a query such as “Whom is the poem in the video written by?” with “The poem in the video is written by Edgar Allan Poe.”

Referring to FIG. 3G, the disclosed mechanisms may respond to a query such as “What are the red texts recognized on the white wall?” with “The red texts recognized on the white wall are ‘GO BOWLING’.”

Referring to FIG. 3H, the disclosed mechanisms may respond to a query such as “Which country does the swimmer who was given a close-up in the video hail from?” with “The swimmer who was given a close-up in the video hails from the USA.”

Referring to FIG. 3I, the disclosed mechanisms may respond to a query such as “What color are his gloves in the video?” with “His gloves are black.”

Referring to FIG. 3J, the disclosed mechanisms may respond to a query such as “Where is this video most likely shot?” with “The video is most likely shot inside a birdhouse.”

Referring to FIG. 3K, the disclosed mechanisms may respond to a query such as “Which hand did the person in the video wear a glove on?” with “The person wore a glove on their right hand.”

Referring to FIG. 3L, the disclosed mechanisms may respond to a query such as “According to the video, why is it very difficult to capture footage of sand cats?” with “Because their fur blends in with their surroundings and their tracks are barely visible.”

Referring to FIG. 3M, the disclosed mechanisms may respond to a query such as “What is this video mainly about?” with “This video is mainly about demonstrating how to fold a shirt. The man in the video shows how to fold a shirt in a step-by-step manner, and he also demonstrates how to fold a t-shirt and a polo shirt.”

Referring to FIG. 3N, the disclosed mechanisms may respond to a query such as “What is the fourth-to-last news item in this news video?A. Josh Liendo swims into the history books. B. Coming soon|Rising demand for pet psychics. C. U.S. vice president calls for Gaza ceasefire. D. California storm drops 2 meters of snow” with “A.”

### LISTING OF DRAWING ELEMENTS

102 SigLIP model
104 downsampling layer
106 multilayer perceptron
108 multimodal large language model
110 linear layer
112 temporal module
114 temporal token compressor
116 spatial and temporal token compressor
202 video-based multimodal large language model
204 Mamba temporal projector
206 image encoder
208 multimodal large language model
210 token
212 video
214 token compressor
216 temporal pooling
218 spatial pooling

The mechanisms disclosed herein utilize artificial neural network components. Artificial neural networks are commonly deployed as components of applications in data centers, desktop and laptop computers, mobile phones, and many other devices, and are generally useful in a wide range of practical applications. For example, artificial neural networks are commonly utilized as the basis of artificial intelligence (AI) systems. Some examples of systems that may incorporate artificial neural networks are high-performance computers and rack systems, vehicles, and robots, to name a few examples.

An artificial neural network comprises, at a high level, a structuring of connected nodes organized into layers, with feed-forward and/or feedback signaling paths configured between the nodes and layers. Signals on the connections between nodes and layers are selectively activated and weighted by amounts determined by the neural network's configuration during training. Practical neural network topologies comprise millions or billions of uniquely configured weights, activation values, and interconnections, as well other settings such as biases and thresholds, encoded as physical electronic states in machine memory. A neural network's structure and layer configurations dictate physical memory access behaviors and electronic activation pathways through hardware computational circuits when executing AI workloads.

Different neural network structures and layer configurations result in different utilizations of computer hardware circuits and memory. Neural networks encoded in computer instructions are highly engineered memory structures that dictate the activation of particular hardware circuits and flow of electrical signals to and through specific memory addresses and hardware circuits of a computer system. Execution of a neural network structure causes specific current flows and energy consumption by specific hardware logic gates in the computer system's processing cores. The specific state changes and hardware component activations induced in a computer system by execution of a particular neural network structure are inseparable from that neural network structure.

During training or inference, any execution pass through neurons and layers of an artificial neural network structure loads network parameters over memory buses, activates specific hardware components (e.g., of GPU tensor cores or CPU ALUs) and triggers the operation of other specific circuits. The structure and configuration of the neural network dictates the physical computation pathways at the microarchitectural level.

Neural network structures are machine-implemented computational architecture that operate analogously to specific electronic circuits. Although a neural network structure may be described to some extent using mathematical formalisms, it exists as a physical, engineered artifact. A computer system comprising an artificial neural network layer structure constitutes “a particular machine,” not a general-purpose computer.

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media configured with machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory, and firmware are examples of logic. Logic specifically excludes pure signals or software per se (however does not exclude non-transitory machine memories comprising software and thereby forming statutory configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the disclosure as claimed. The scope of inventive subject matter is not limited to the depicted embodiments but is rather set forth in the following Claims.

What is claimed is:

1. A system comprising:
an image encoder configured to transform frames from a video into visual tokens;
a multimodal large language model configured to receive the visual tokens; and
a temporal module interposed between the image encoder and the multimodal large language model.

2. The system of claim 1, wherein the image encoder comprises a SigLIP model.

3. The system of claim 1, wherein the temporal module comprises a Mamba temporal projector.

4. The system of claim 3, further comprising a token compressor interposed between the Mamba temporal projector and the multimodal large language model.

5. The system of claim 4, wherein the Mamba temporal projector comprises a spatial and temporal token compressor.

6. The system of claim 1, further comprising a downsampling layer interposed between the image encoder and the temporal module.

7. The system of claim 6, further comprising a linear layer interposed between the downsampling layer and the temporal module.

8. A process comprising:
operating an image encoder to transform frames from a video into visual tokens; and
operating a multimodal large language model to receive the visual tokens via a temporal module interposed between the image encoder and the multimodal large language model.

9. The process of claim 8, wherein the image encoder comprises a SigLIP model.

10. The process of claim 8, wherein the temporal module comprises a Mamba temporal projector.

11. The process of claim 10, further comprising:
operating a temporal token compressor interposed between the Mamba temporal projector and the multimodal large language model.

12. The system of claim 11, wherein the Mamba temporal projector comprises a spatial and temporal token compressor.

13. The system of claim 8, further comprising a downsampling layer interposed between the image encoder and the temporal module.

14. The system of claim 13, further comprising a linear layer interposed between the downsampling layer and the temporal module.

15. A computer system comprising:
at least one data processor; and
logic configured to:
operate an image encoder to transform frames from a video into visual tokens; and
operate a multimodal large language model to receive the visual tokens via a temporal module interposed between the image encoder and the multimodal large language model.

16. The computer system of claim 15, wherein the image encoder comprises a SigLIP model.

17. The computer system of claim 15, wherein the temporal module comprises a Mamba temporal projector.

18. The computer system of claim 17, the logic further configured to:
operate a temporal token compressor interposed between the Mamba temporal projector and the multimodal large language model.

19. The computer system of claim 18, wherein the Mamba temporal projector comprises a spatial and temporal token compressor.

20. The system of claim 15, further comprising a downsampling layer interposed between the image encoder and the temporal module.

21. The system of claim 20, further comprising a linear layer interposed between the downsampling layer and the temporal module.
